(19) United States
(12) Patent Application Publication
(10) Pub. No.: US 2010/0175181 A1
(43) Pub. Date: Jul. 15, 2010

(54) CLEANING ASSEMBLY WITH WATER FULL OF NANO-SCALE BUBBLES FOR STERILIZATION, REHABILITATION AND THERAPY

(76) Inventor: Kuo Kang CHEN, Taipei (TW)

Correspondence Address: LAW OFFICES OF KHALILIAN SIRA, LLC, 9100 PERSIMMON TREE ROAD, POTOMAC, MD, 20854, US

(21) Appl. No.: 12/354,089

(22) Filed: Jan. 15, 2009

(51) Int. Cl. A61H 33/02

(52) U.S. Cl. 4/541.5

(57) ABSTRACT

A cleaning assembly has a reservoir, a pressurized loop and a cleaning head. The reservoir contains water having oxygen and ozone. The pressurized loop provides a means for adding ozone and oxygen to water at high pressure and dropping water pressure to a comfortable level. The cleaning head is detachably connected to the reservoir by a sheath and a quick coupling and has a distribution cup having multiple protrusions. The cleaning head applies water having oxygen and ozone for cleaning excretory and reproductive organs.

### BACKGROUND OF THE INVENTION

1. Field of Invention

The present invention relates to a cleaning assembly, and more particularly to a cleaning assembly providing water full of nano-scale bubbles for cleaning, disinfecting and repairing, especially for excretory and reproductive organs.

2. Description of the Related Art

Excretory and reproductive organs are difficult to keep clean during regular bathing due to skin sensitivity and intricacy. Further, excretory and reproductive organs are warm, moist and not frequently exposed to light so are vulnerable to infections, fungal growth and putrefactions, which release odor. Female reproductive organs must be carefully maintained to avoid infectious gynecologic diseases. Additionally, reproductive organs may be infected due to sexual behavior. Therefore, keeping the excretory and reproductive organs clean is important for reducing possible infection and improved comfort.

Further, after prolonged periods of inactivity, especially sitting circulation around a seat is reduced contributing to hemorrhoids, dermatitis or the like. Therefore, effective cleaning apparatus for excretory and reproductive organs is required.

Mixed gas including oxygen and ozone and water solution including oxygen and ozone have been used for sterilization and tissue-reparation because free radicals are generated in the water from ozone.

Specifically, ozone can kill viruses, pathogens, spores, fungi, bacteria, and especially affects mycoplasma, chlamydia or the like. Therefore, ozone is used to cure chronic vaginitis, cervicitis, pelvic inflammatory disease, cervical erosion or other gynecologic diseases. Both in gaseous state or dissolved in water, ozone can rapidly cure patients and is naturally broken down so requires no specific environmental disposal.

Furthermore, oxygen activates a cell activity to enhance a growth of epithelium and accelerates healing of suppuration, fester or the like. Therefore, oxygen effectively repairs suppurate, fester or other wounds.

To overcome the shortcomings, the present invention provides a cleaning assembly with water full of nano-scale bubbles for sterilization, rehabilitation and therapy to mitigate or obviate the aforementioned.

### SUMMARY OF THE INVENTION

The primary objective of the present invention is to provide a cleaning assembly that provides water full of nano-scale bubbles for cleaning, disinfecting and repairing, especially for excretory and reproductive organs.

To achieve the objective, a cleaning assembly in accordance with the present invention comprises a reservoir, a pressurized loop, a sink, a cleaning-water inlet and a bath. The reservoir has a water outlet. The pressurized loop connects the cleaning-water inlet and sequentially has an oxygen supply, an ozone generator, a circulating pump, a pressure-balancing apparatus and an aerator. The sink connects the reservoir. The cleaning-water inlet has a proximal end and a distal. The proximal end of the cleaning-water inlet connects and communicates with the aerator of the pressurized loop. The distal end has a cleaning head. The cleaning head detachably connects the distal end. The bath connects and communicates with the cleaning-water inlet.

The cleaning head applies water full of oxygen and ozone to clean users' excretory organs or reproductive organs. The users also conveniently clean their bodies in the bath using water full of oxygen and ozone and obtain water full of oxygen and ozone from the sink.

Other objectives, advantages and novel features of the invention will become more apparent from the following detailed description when taken in conjunction with the accompanying drawings.

### BRIEF DESCRIPTION OF THE DRAWINGS

FIG. 1 is a schematic diagram of a cleaning assembly in accordance with the present invention;

FIG. 2 is a cross-sectional side view of an aerator in a cleaning assembly in accordance with the present invention;

FIG. 3 is a side view of a male cleaning head in a cleaning assembly in accordance with the present invention;

FIG. 4 is a side view of a female cleaning head in a cleaning assembly in accordance with the present invention; and

FIG. 5 is an end view of the female cleaning head in a cleaning assembly in FIG. 4.

### DETAILED DESCRIPTION OF THE INVENTION

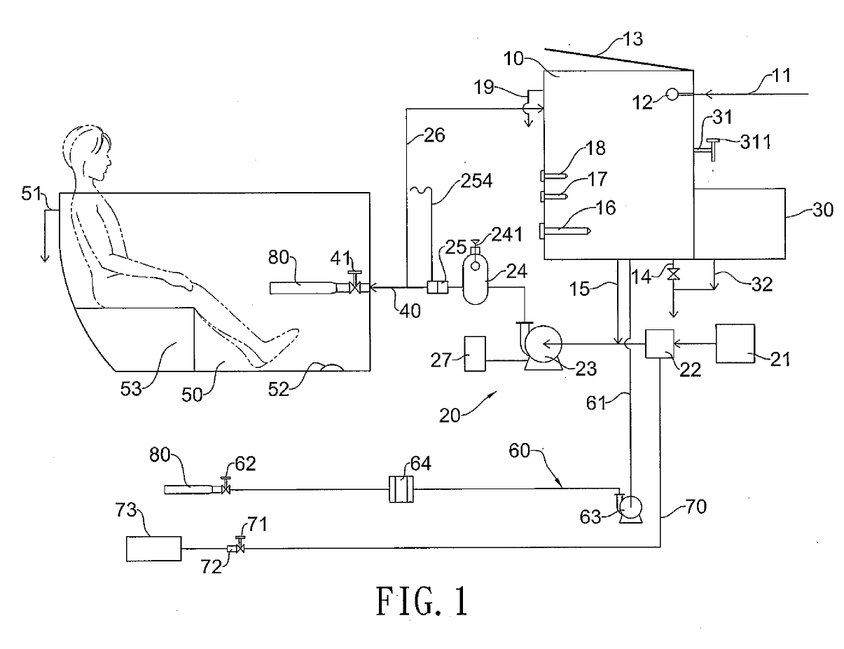

With reference to FIG. 1, a cleaning assembly in accordance with the present invention comprises a reservoir (10), a pressurized loop (20), a sink (30), a cleaning-water inlet (40), a bath (50), an electrolytic ozone generation assembly (60) and an air pipe (70).

The reservoir (10) is an open container having a chamber, a cover (13) a water inlet (11), a drain (14), a water outlet (15), a heater (16), a dissolved oxygen sensor (17), a dissolved ozone sensor (18) and an overflow (19). The cover (13) detachably closes and seals the reservoir (10). The chamber is filled with water containing oxygen and ozone. The water inlet (11) is mounted through and automatically fills the reservoir (10) with water and may comprise a float valve (12). The drain (14) is mounted through the reservoir (10). The water outlet (15) is mounted through the reservoir (10). The heater (16) is mounted in the chamber and heats the water. The dissolved oxygen sensor (17) is mounted in the chamber and detects concentration of dissolved oxygen in the water. The dissolved ozone sensor (18) is mounted in the chamber and detects concentration of dissolved ozone in the water. The overflow (19) is mounted through the reservoir (10) to prevent the reservoir (10) from being overfilled and flooding so causing damage or electric hazard.

The pressurized loop (20) sequentially comprises an oxygen supply (21), an ozone generator (22), a circulating pump (23), a pressure-balancing apparatus (24) and an aerator (25), which are sequentially connected to each other by a pipe.

The oxygen supply (21) may provide 90% oxygen and may be an oxygen generator or an oxygen cylinder.

The ozone generator (22) is connected to the oxygen supply (21) and the water outlet (15) of the reservoir (10).

The circulating pump (23) is connected to the water outlet (15) of the reservoir (10), the ozone generator (22) and a frequency transformer (27). After water passes through the circulating pump (23), water pressure is about 7˜10 kg/cm²G and a dissolved oxygen concentration is at least 50 ppm, compared to about 7 ppm in tap water. Therefore, water via the circulating pump (23) is oxygenated, so able to activate tissue such as epithelial tissue or the like and heal wounds or affected parts rapidly.

The pressure-balancing apparatus (24) is connected to the circulating pump (23) and has a relief valve (241).

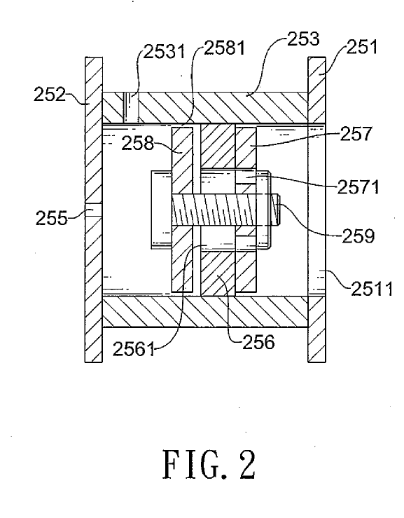

With further reference to FIG. 2, the aerator (25) is connected to the pressure-balancing apparatus (24) and has a hollow barrel (253), a ring bracket (251), a sealing board (252), a ventilation pipe (254) and a backflow pipe (26).

The hollow barrel (253) has an inlet end, an outlet end, an inner chamber, a sidewall, a surrounding ring (256), a flow distribution baffle (257), a pressure-relieving diffusion baffle (258) and a ventilation hole (2531). The surrounding ring (256) is mounted in the inner chamber, protrudes from the sidewall and has a central hole (2561), a proximal end and a distal end. The central hole (2561) is formed through the surrounding ring (256), allows water to flow through the central hole (2561) and also allows a bolt (259) to extend through the central hole (2561). The flow distribution baffle (257) is mounted on and abuts the proximal end of the surrounding ring (256) and has multiple through holes (2571) and a central mounting hole. The through holes (2571) are defined through the flow distribution baffle (257), communicate with the central hole (2561) of the surrounding ring (256) and allow water to flow through the through holes (2571). The central mounting hole is defined through the flow distribution baffle (257), communicates with the central hole (2561) of the surrounding ring (256) and allows the bolt (259) to extend through the central mounting hole. The pressure-relieving diffusion baffle (258) is mounted near the distal end of the surrounding ring (256), is screwed with the flow distribution baffle (257) and has a threaded hole and an interval (2581). The threaded hole is screwed to the bolt (259) to fasten the pressure-relieving diffusion baffle (258) to the flow distribution baffle (257). An interval (2581) is formed between the pressure-relieving diffusion baffle (258) and the surrounding ring (256) and between the pressure-relieving diffusion baffle (258) and the sidewall and allows water to flow through the interval (2581). The ventilation hole (2531) is defined through the sidewall near the outlet end.

The ring bracket (251) is mounted on the inlet end of the hollow barrel (253) and has an opening (2511). The opening (2511) is formed in the ring bracket (251) and communicates with the inner chamber of the hollow barrel (253). A diameter of the opening (2511) may be equal to a diameter of the inner chamber of the hollow barrel (253).

The sealing board (252) is mounted on the outlet end of the hollow barrel (253) and has a passing hole (255). The passing hole (255) is defined through the sealing board (252) and communicates with the inner chamber of the hollow barrel (253). A diameter of the through hole is much smaller than the diameter of the opening (2511).

The ventilated pipe (254) is connected to the ventilation hole (2531) and an outside environment to control a pressure in the inner chamber of the hollow barrel (253).

The backflow pipe (26) is connected to the aerator (25), communicates with the passing hole (255) and is connected to the reservoir (10) and allows water to flow back to the reservoir (10).

Therefore, water enters the aerator (25) from the opening (2511) of the ring bracket (251), then flows through the through holes (2571) of the flow distribution baffle (257), the central hole (2561) in the surrounding ring (256), the interval (2581) and flows out of the aerator (25) via the passing hole (255) of the sealing board (252).

Furthermore, after water flows through the aerator (25), water pressure reaches about 100 to 200 cm-H₂O and multiple bubbles are generated in water while each bubble has a diameter from about 10 nm to about 20 nm. When water pressure is lower than 7 kg/cm²G, bubbles generated in water are almost micro-scale. When water pressure is between about 7˜9 kg/cm²G, bubbles generated in water are almost nano-scale. Bubbles stay in water for about 2˜3 minutes, before the bubbles release oxygen to environment, otherwise the bubbles may contact a surface, such as skin and release oxygen. When ozone is dissolved in water, the ozone is hydrated and releases ions that flocculate organic matter, such as but not limited to furfur.

The sink (30) is connected to the reservoir (10), may be mounted on the reservoir (10) and has an input pipe (31) and an output pipe (32). The input pipe (31) is mounted through the reservoir (10) to provide water to the sink (30) and has a valve. The output pipe (32) is connected to the sink (30) and may be connected to the drain (14) of the reservoir (10) for convenient disposal.

The cleaning-water inlet (40) has a proximal end, a distal end and a valve (41). The proximal end is connected to the backflow pipe (26). The distal end has a cleaning head (80). The cleaning head (80) is detachably connected to the distal end of the cleaning-water inlet (40). The valve (41) is mounted near the distal end of the cleaning water outlet (40) and controls a flow rate of water in the cleaning-water inlet (40).

The bath (50) is connected to the cleaning-water inlet (40) and has a water mount, an overflow (51), a drain, a plug (52) and a seat (53). The water mount is defined through the bath (50) and around the cleaning-water inlet (40). The overflow (51) is mounted though the bath (50) and controls a water level in the bath (50). The drain of the bath (50) is formed through the bath (50) and communicates with the recess. The plug (52) selectively seals the drain. The seat (53) is mounted in the bath (50).

The electrolytic ozone generation assembly (60) has a connecting pipe (61), a water pump (63) and an electrolytic ozone generator (64). The connecting pipe (61) has a proximal end, a distal end, a valve (62) and a cleaning head (80). The proximal end of the connecting pipe (61) is connected to the reservoir (10). The valve (62) is mounted on the connecting pipe (61) near the distal end. The cleaning head (80) is detachably connected to the distal end of the connecting pipe (61). The water pump (63) is used to pump water from the reservoir (10) to the distal end of the connecting pipe (61). The electrolytic ozone generator (64) is used to generate 5˜10 mg/L of ozone in a short time.

The air pipe (70) has a proximal end, a distal end, an adjusting valve (71), a flow meter (72) and a gas outlet (73). The proximal end of the air pipe (70) is connected to the ozone generator (22) of the pressurized loop (20). The adjusting valve (71) is used to control a flow rate of air in the air pipe (70). The flow meter (72) is used to detect the flow rate of air in the air pipe (70). The gas outlet (73) is mounted on the distal end of the air pipe (70) and may be a cleaning head (80), a conventional diffuser or the like.

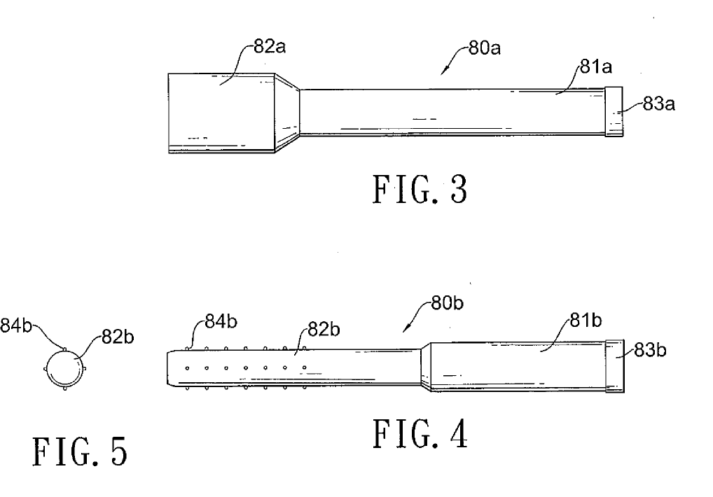

With further reference to FIGS. 3 to 5, the cleaning head (80) corresponds to a genital region and comprises a sheath part (81a, 81b), a distribution cup (82a, 82b) and a quick coupling (83a, 83b). The sheath part (81a, 81b) is mounted over the cleaning water inlet (40), the connecting pipe (61) or the air pipe (70). The quick coupling (83a, 83b) is formed on the sheath part (81a, 81b) and detachably connects cleaning head to an input and may be detachably mounted on the cleaning-water inlet (40), the connecting pipe (61) or the air pipe (70). The distribution cup (82a, 82b) is used to clean excretory and reproductive organs and comprises multiple protrusions (84b).

The cleaning head (80) may be a male cleaning head (80a) or a female cleaning head (80b) respectively having a male distribution cup (82a) and a female distribution cup (82b).

The male distribution cup (82a) of the male cleaning head (80a) comprises a distal cup for effective cleaning of male genitalia.

The female distribution cup (82b) of the female cleaning head (80b) has a shaft through which the protrusions (84b) are formed and may protrude from at intervals for effective cleaning of female genitalia. The cleaning part (82b) of the female cleaning tube (80b) has an outer surface and multiple protrusions (84b). The protrusions (84b) protrudes from the outer surface at intervals, which is able to space the cleaning part (82b) from an inner surface of the female's vulva and allows water and air to flow in or out of the female's vulva smoothly when the cleaning part (82b) is in the female's vulva

The cleaning assembly is connected to a tap water supply via the water inlet (11), water flows through the pressurized loop (20) via the water outlet (15) and is pumped by the circulating pump (23). The water is pressurized by the circulating pump (23), and contains oxygen from the oxygen supply (21) and ozone from the ozone generator (22). Water passes through the aerator (25) to form multiple micron- and nano-scale bubbles of oxygen and ozone and water pressure of about 200 cm-H₂O. Water having oxygen and ozone bubbles returns to the reservoir (10) at suitable pressure for use or flows to the cleaning-water inlet (40).

The heater (16) in the reservoir (10) may heat the water to 30-35° C. for comfort. The dissolved oxygen sensor (17) and the dissolved ozone sensor (18) are used to detect concentrations of oxygen and ozone dissolved in water. The valve (41) of the cleaning-water inlet (40) may be activated to fill the bath (50) for regular bathing. During bathing, the seat (53) may be used and the cleaning head (80) attached to the cleaning-water inlet (40) to direct water having ozone and oxygen bubbles toward reproductive and excretory organs for effective cleaning since ozone and oxygen are able to contact directly with the user to heal and prevent diseases including cervical cancer. Further, water in the reservoir (10) pumped into the connecting pipe (61) of the electrolytic ozone generation assembly (60) by the water pump (63) may be used for site specific cleaning. After cleaning user's body, the user pulls up the seal (52) and drain out used water via the drain in the bottom of the bath (50). In this embodiment of the present invention, water in the bath (50) is only used once.

However, the person skilled in the art may design a recycle system including a filter to filter the used water to use the used water more times to save water.

Water from the input pipe (31) of the sink (30) may be used to drink, brush teeth, rinse mouth, wash face, clean tools such as a razor, medical apparatus or the like. The input pipe (31) of the sink (30) provided water with 10˜50 mg/L of ozone for clean or immerse the medical apparatus for prompt sterilization.

In other case, water in the reservoir (10) was pumped into the connecting pipe (61) of the electrolytic ozone generation assembly (60) by the water pump (63). The user may use the cleaning tube (80′) to output water full of oxygen and ozone to clean user's excretory organ or reproductive organ.

Further, air from the air pipe (70) comprises a mixture of oxygen and ozone and may be used to treat a wound, an affected part or the like for improved healing.

Generally, water with more than 4 mg/L of ozone is able to disinfect vital bacteria such as mold in one minute. When the ozone concentration is higher, the speed of sterilization is faster. Water in the present invention provides water with more than 5 mg/L of ozone to promptly heal and sterilize wounds or affected parts. Further, water in the sink (30) may be used to clean the cleaning head (80) after use for improved hygiene.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A cleaning assembly comprising:
a reservoir having
a chamber;
a water inlet being mounted through the reservoir;
a drain being mounted through the reservoir;
a water outlet being mounted through the reservoir; and
a pressurized loop sequentially comprising
an oxygen supply;
an ozone generator being connected to the oxygen supply and the water outlet of the reservoir;
a circulating pump being connected to the water outlet of the reservoir and the ozone generator;
a pressure-balancing apparatus being connected to the circulating pump; and
an aerator being connected to the pressure-balancing apparatus;
a backflow pipe connected to the aerator and communicating with the aerator and the reservoir;
a sink having an input pipe being mounted through the reservoir;
a cleaning-water inlet having
a proximal end being connected to the backflow pipe;
a distal end having a cleaning head detachably connected to the distal end; and
a valve being mounted near the distal end of the cleaning-water inlet; and
a bath being connected to the cleaning-water inlet.

2. The cleaning assembly as claimed in claim 1, wherein the cleaning head has
a sheath part having
an end; and
a quick coupling sheathing the end of the sheath part and connecting the cleaning-water inlet; and
a distribution cup.

3. The cleaning assembly as claimed in claim 2, wherein the cleaning head is selected from a male cleaning head and a female cleaning head, wherein
the distribution cup of the male cleaning head has a diameter that is larger than a diameter of the sheath part;
the distribution cup of the female cleaning head has
a diameter that is larger than a diameter of the sheath part of the female cleaning head;
an outer surface; and
multiple protrusions protruding from the outer surface at intervals.

4. The cleaning assembly as claimed in claim 3, wherein the aerator has
a hollow barrel having
an inlet end;
an outlet end;
an inner chamber;
a sidewall;
a surrounding ring being mounted in the inner chamber, protruding from the sidewall and having
a central hole being formed through the surrounding ring and allowing a bolt to extend through the central hole;
a proximal end; and
a distal end;
a flow distribution baffle being mounted on and abutting the proximal end of the surrounding ring and having
multiple through holes being defined through the flow distribution baffle and communicating with the central hole of the surrounding ring; and
a central mounting hole being defined through the flow distribution baffle, communicating with the central hole of the surrounding ring and allowing the bolt to extend through the central mounting hole;
a pressure-relieving diffusion baffle being mounted near the distal end of the surrounding ring, being screwed with the flow distribution baffle and having
a threaded hole being screwed to the bolt to fasten the pressure-relieving diffusion baffle to the flow distribution baffle; and
an interval being formed between the pressure-relieving diffusion baffle and the surrounding ring and between the pressure-relieving diffusion baffle and the sidewall; and
a ventilation hole being defined through the sidewall near the outlet end of the hollow barrel;
a ring bracket being mounted on the inlet end of the hollow barrel and having an opening being formed in the ring bracket and communicating with the inner chamber of the hollow barrel;
a sealing board being mounted on the outlet end of the hollow barrel and having a passing hole being defined through the sealing board and communicating with the inner chamber of the hollow barrel;
a ventilated pipe connecting and communicating the ventilation hole; and
a backflow pipe connecting and communicating the passing hole and the reservoir.

5. The cleaning assembly as claimed in claim 4, wherein after water flows through the aerator, multiple bubbles are generated in water and each bubble has a diameter from about 10 nm to about 20 nm.

6. The cleaning assembly as claimed in claim 4, wherein after water passes through the circulating pump, a dissolved oxygen concentration in water is at least 50 ppm.

7. The cleaning assembly as claimed in claim 1, further comprising an electrolytic ozone generation assembly having
a connecting pipe having
a proximal end connecting and communicating with the reservoir;
a distal end;
a valve being mounted on the connecting pipe near the distal end; and
the cleaning head of the cleaning-water inlet detachably connecting the distal end of the connecting pipe;
a water pump used to pump water from the reservoir to the distal end of the connecting pipe; and
an electrolytic ozone generator being used to generate ozone.

8. The cleaning assembly as claimed in claim 2, further comprising an electrolytic ozone generation assembly having
a connecting pipe having
a proximal end connecting and communicating with the reservoir;
a distal end;
a valve being mounted on the connecting pipe near the distal end; and
the cleaning head of the cleaning-water inlet detachably connected to the distal end of the connecting pipe; and
an electrolytic ozone generator being used to generate ozone.

9. The cleaning assembly as claimed in claim 3, further comprising an electrolytic ozone generation assembly having
a connecting pipe having
a proximal end connecting and communicating with the reservoir;
a distal end;
a valve being mounted on the connecting pipe near the distal end; and
the cleaning head of the cleaning-water inlet detachably connected to the distal end of the connecting pipe;
a water pump used to pump water from the reservoir to the distal end of the connecting pipe; and
an electrolytic ozone generator being used to generate ozone.

10. The cleaning assembly as claimed in claim 4, further comprising an electrolytic ozone generation assembly having
a connecting pipe having
a proximal end connecting and communicating with the reservoir;
a distal end;
a valve being mounted on the connecting pipe near the distal end; and
the cleaning head of the cleaning-water inlet detachably connected to the distal end of the connecting pipe;
a water pump used to pump water from the reservoir to the distal end of the connecting pipe; and
an electrolytic ozone generator being used to generate ozone.

11. The cleaning assembly as claimed in claim 1, wherein the reservoir further has an air pipe having
a proximal end connecting and communicating with the ozone generator of the pressurized loop;
a distal end;
an adjusting valve;
a flow meter; and
a gas outlet being mounted on the distal end of the air pipe.

12. The cleaning assembly as claimed in claim 2, wherein the reservoir further has an air pipe having
a proximal end connecting and communicating with the ozone generator of the pressurized loop;
a distal end;
an adjusting valve;
a flow meter; and
a gas outlet being mounted on the distal end of the air pipe.

13. The cleaning assembly as claimed in claim 3, wherein the reservoir further has an air pipe having
a proximal end connecting and communicating with the ozone generator of the pressurized loop;
a distal end;
an adjusting valve;
a flow meter; and
a gas outlet being mounted on the distal end of the air pipe.

14. The cleaning assembly as claimed in claim 4, wherein the reservoir further has an air pipe having
a proximal end connecting and communicating with the ozone generator of the pressurized loop;
a distal end;
an adjusting valve;
a flow meter; and
a gas outlet being mounted on the distal end of the air pipe.

15. The cleaning assembly as claimed in claim 1, wherein the reservoir further has
an open top;
a cover detachably covering the open top;
a heater being mounted in the chamber;
a dissolved oxygen sensor being mounted in the chamber;
a dissolved ozone sensor being mounted in the chamber; and wherein the water inlet of the reservoir has a float valve.

16. The cleaning assembly as claimed in claim 2, wherein the reservoir further has
an open top;
a cover detachably covering the open top;
a heater being mounted in the chamber;
a dissolved oxygen sensor being mounted in the chamber;
a dissolved ozone sensor being mounted in the chamber; and wherein the water inlet of the reservoir has a float valve.

17. The cleaning assembly as claimed in claim 3, wherein the reservoir further has
an open top;
a cover detachably covering the open top;
a heater being mounted in the chamber;
a dissolved oxygen sensor being mounted in the chamber;
a dissolved ozone sensor being mounted in the chamber; and wherein the water inlet of the reservoir has a float valve.

18. The cleaning assembly as claimed in claim 1, wherein the bath further has
a closed bottom;
an open top;
at least one sidewall having a mounting hole being defined through the sidewall and allowing the cleaning-water inlet to extend through the mounting hole and to communicate with the recess in the bath;
a overflow connecting the sidewall near the top of the bath and communicating the recess in the bath;
an drain being defined through the bottom of the bath and communicating with the recess of the bath;
a plug detachably plugging the drain; and
a seat being mounted in the recess of the bath.

19. The cleaning assembly as claimed in claim 2, wherein the bath further has
a closed bottom;
an open top;
at least one sidewall having a mounting hole being defined through the sidewall and allowing the cleaning-water inlet to extend through the mounting hole and to communicate with the recess in the bath;
a overflow connecting the sidewall near the top of the bath and communicating with the recess in the bath;
an drain being defined through the bottom of the bath and communicating with the recess of the bath;
a plug detachably plugging the drain; and
a seat being mounted in the recess of the bath.

20. The cleaning assembly as claimed in claim 3, wherein the bath further has
a closed bottom;
an open top;
at least one sidewall having a mounting hole being defined through the sidewall and allowing the cleaning-water inlet to extend through the mounting hole and to communicate with the recess in the bath;
a overflow connecting the sidewall near the top of the bath and communicating with the recess in the bath;
an drain being defined through the bottom of the bath and communicating with the recess of the bath;
a plug detachably plugging the drain; and
a seat being mounted in the recess of the bath.
